(19) United States
(12) Patent Application Publication
(10) Pub. No.: US 2023/0212721 A1
(43) Pub. Date: Jul. 6, 2023

(54) STEEL, STEEL MECHANICAL PART, ELECTRONIC DEVICE, AND PREPARATION METHOD FOR STEEL MECHANICAL PART

(71) Applicants: HUAWEI TECHNOLOGIES CO., LTD., Shenzhen (CN); Shenzhen ElementPlus Material Technology Co., Ltd., Shenzhen (CN)

(72) Inventors: Xiaoming Xu, Shenzhen (CN); Ming Cai, Dongguan (CN); Wei Yuan, Dongguan (CN); Yonghu Lv, Shenzhen (CN); Wei Mo, Shenzhen (CN)

(21) Appl. No.: 18/174,373

(22) Filed: Feb. 24, 2023

Related U.S. Application Data
(63) Continuation of application No. PCT/CN2021/102352, filed on Jun. 25, 2021.

(30) Foreign Application Priority Data
Aug. 24, 2020 (CN) 202010858216.7
Jan. 30, 2021 (CN) 202110134557.4

(51) Int. Cl. C22C 38/52; C22C 38/48; C22C 38/44; C22C 38/04; C22C 38/02; C22C 38/00; H01F 1/147

(52) U.S. Cl. CPC C22C 38/52; C22C 38/48; C22C 38/44; C22C 38/04; C22C 38/02; C22C 38/002; H01F 1/14708; B22F 3/225

(57) ABSTRACT

A steel, a steel mechanical part, an electronic device, and a preparation method for a steel mechanical part are provided. The steel includes components of the following mass percentages: chromium: 7% to 11%, nickel: 2% to 7.5%, cobalt: 6% to 15%, molybdenum: 4% to 7%, oxygen: a trace to 0.4%, carbon: a trace to 0.35%, and iron: 50% to 80%. The steel provided in this application has relatively high mechanical strength and is not easily deformed, and therefore a risk of fracture caused when an electronic device using the steel falls off from a height is reduced.

### CROSS-REFERENCE TO RELATED APPLICATIONS

This application is a continuation of International Application No. PCT/CN2021/102352, filed on Jun. 25, 2021, which claims priority to Chinese Patent Application No. 202010858216.7, filed on Aug. 24, 2020 and Chinese Patent Application No. 202110134557.4, filed on Jan. 30, 2021. All of the aforementioned patent applications are hereby incorporated by reference in their entireties.

### TECHNICAL FIELD

This application relates to the field of steel technologies, and in particular, to steel, a steel mechanical part, an electronic device, and a preparation method for a steel mechanical part.

### BACKGROUND

Currently, electronic devices such as a mobile phone, a tablet computer, and a computer use many steel mechanical parts. For example, a rotating shaft component in a folding mobile phone uses a steel mechanical part, to bear specific force and be not easily deformed. However, in a conventional technology, strength of the steel mechanical part used by the rotating shaft component in the folding mobile phone is limited. When an electronic device falls off from a height, the steel mechanical part easily fractures. Consequently, quality of the electronic device is affected.

### SUMMARY

This application provides steel with relatively high structural strength, so that a risk of steel fracture caused in a process in which an electronic device using the steel falls off is reduced, and therefore quality of the electronic device is improved. This application further provides a steel mechanical part, a preparation method for the steel mechanical part, and an electronic device that includes the steel mechanical part.

According to a first aspect, this application provides steel. The steel includes components of the following mass percentages:

chromium: 7% to 11%, nickel: 2% to 7.5%, cobalt: 6% to 15%, molybdenum: 4% to 7%, oxygen: a trace to 0.4%, carbon: a trace to 0.35%, and iron: 50% to 80%.

Chromium plays a decisive role in corrosion resistance of the steel. In this embodiment of this application, a mass percentage of the chromium is less than or equal to 11%, to avoid a case in which strength of the steel mechanical part is relatively low because the steel mechanical part forms ferrite due to excessively high content of chromium. In addition, the mass percentage of the chromium is greater than or equal to 7%, to avoid a case in which strength of the steel mechanical part is reduced because excessively low content of chromium reduces an Ms point of the steel and suppresses precipitation of a Laves phase. The Laves phase is an intermetallic compound whose chemical formula is mainly a close-packed cubic or hexagonal structure of an AB2 type. The Laves phase is a second phase in a steel material. When the second phase is evenly distributed in a matrix phase by using fine and dispersed particles, a significant reinforcing effect is generated. This reinforcing effect is referred to as second phase reinforcing.

Nickel is an important austenite stabilized element in the steel and also an important tough element in the steel. In this embodiment of this application, a mass percentage of the nickel is greater than or equal to 2%, so that a cleavage fracture resistance capability of a martensitic structure in the steel mechanical part is improved, and sufficient toughness of the steel mechanical part is ensured. In addition, the mass percentage of the nickel is less than or equal to 7.5%, to avoid a case in which austenite is prevented from being converted into martensite in a quenching processing process due to existence of excessive nickel, so that strength of the steel mechanical part is increased.

Cobalt promotes formation of the austenite in a process of preparing the steel, and helps improve toughness of the steel mechanical part. In addition, cobalt can delay recovery of a dislocation substructure of the martensite, maintain high dislocation density of a martensite lath, and promote formation of a precipitate phase. Cobalt is an austenite stabilized element. When content of cobalt is excessively high, stabilized austenite is formed in an alloy, and cannot be converted to martensite in a quenching process, and consequently, a matrix is prevented from achieving high strength. Content of cobalt is defined as 6% to 15%.

Mmolybdenum can promote formation of a reinforcing phase, such as the Laves phase and molybdenum carbide, so that strength of the steel mechanical part is increased. In addition, molybdenum is a ferrite stabilized element, and if there is excessive molybdenum, excessive austenite is generated in an alloy and is converted into stable ferrite, and consequently, matrix strength is reduced. Content of molybdenum is defined as 4% to 7%.

Carbon is one of the most common elements in the steel and one of austenite stabilized elements. In addition, carbon can improve hardenability of the steel. In a Fe—Cr—Ni—Co—Mo system, MC (such as Mo2C or W2C) carbide can also be generated to increase the matrix strength. Excessive carbon is combined with chromium in the matrix to form a series of complex carbide, and this makes it difficult to control a structure. Therefore, content of carbon is defined as less than or equal to 0.35%.

In this embodiment of this application, a mass percentage of each component in the steel is limited, so that the steel can be reinforced by relying on a Fe—Co—Ni—Cr—Mo phase, a Fe—Co—Cr—Mo phase, and carbide (such as Mo2C or W2C), and therefore the steel is characterized by both high strength and high toughness, and the steel is not prone to deformation or fracture under high-strength force.

The mass percentage of each component in the steel is different, and components of the reinforcing phase are also different; in other words, a formed Fe—Co—Ni—Cr—Mo phase, Fe—Co—Cr—Mo phase, or carbide is different. The reinforcing phase may be but is not limited to (Fe, Co, Ni)17Cr8Mo18, (Fe, Co)15Cr8Mo4, (Fe, Co)16Cr8Mo18, or the like.

In some embodiments, yield strength of the steel is greater than or equal to 1300 Mpa, and elongation is greater than or equal to 3%.

In this embodiment of this application, the yield strength of the steel is greater than or equal to 1300 Mpa, and the elongation is greater than or equal to 3%, to reduce a risk that the steel mechanical part fractures and fails in a process in which the electronic device using the steel falls off. In addition, the steel has relatively high strength, and the steel mechanical part using the steel does not need to ensure reliability of the steel mechanical part by increasing thickness, and this is conducive to miniaturization of the steel mechanical part, and is conducive to miniaturization of the electronic device.

In some embodiments, the yield strength of the steel is less than or equal to 2000 Mpa, and the elongation is less than or equal to 12%.

It may be understood that, greater yield strength of the steel and greater elongation lead to a more difficult method for preparing the steel. In this embodiment of this application, the yield strength of the steel is less than or equal to 2000 Mpa, and the elongation is less than or equal to 12%. Therefore, while it is ensured that the steel has relatively high mechanical strength, difficulty in the method for preparing the steel is reduced, so that production costs of the steel are reduced.

In some embodiments, the steel further includes silicon and manganese, a mass percentage of the silicon is a trace to 0.5%, and a mass percentage of the manganese is a trace to 0.5%.

Silicon may be used as a deoxidizing agent for molten steel in a process of preparing steel powder, and can also increase fluidity of the molten steel. In addition, a small amount of silicon is retained in the matrix, and may exist in a form of an oxide inclusion, so that the matrix strength is increased. Content of silicon is defined as a trace to 0.5%.

Manganese has a deoxidization and desulfurization effect in the steel. In the process of preparing the steel powder, manganese can remove oxygen and sulfur in the molten steel, and is also an element that ensures hardenability. Similar to a role of silicon, when content of manganese is excessively high, toughness of the steel is significantly reduced. Therefore, in this application, the content of manganese is controlled as a trace to 0.5%.

In this embodiment of this application, the steel mechanical part further includes silicon and manganese, and a mass percentage of the silicon or the manganese is a trace to 0.5%, to effectively increase strength of the steel mechanical part.

In some embodiments, a mass percentage of the chromium is 7% to 9%, and a mass percentage of the cobalt is 7% to 14%.

In some embodiments, the steel further includes niobium, and a mass percentage of the niobium is a trace to 1%.

Niobium may be solid solved in the steel, and causes lattice distortion, to play a role of solid solution reinforcing, and in addition, niobium is also a carbide forming element, and can play a role of refining grains and reinforcing precipitation.

In this embodiment of this application, the steel mechanical part further includes niobium. The steel mechanical part can form Fe2Nb and NbC, and the formed Fe2Nb and the formed NbC increase the strength of the steel mechanical part. In addition, the mass percentage of the niobium is less than or equal to 1%, to avoid a case in which a brittle phase is precipitated along a grain boundary due to excessively high content of niobium, so that strength and toughness of a steel structure are increased.

In some embodiments, the steel further includes tantalum, and a mass percentage of the tantalum is a trace to 2%.

In some embodiments, the steel further includes both tantalum and niobium, a ratio of a mass percentage of the tantalum to a mass percentage of the niobium is (1 to 2):1, and the mass percentage of the tantalum plus the mass percentage of the niobium is a trace to 1.5%.

In some embodiments, the steel further includes tungsten, and a mass percentage of the tungsten is a trace to 2%. For example, the steel mechanical part includes components of the following mass percentages: chromium: 7% to 11%, nickel: 2% to 7.5%, cobalt: 6% to 15%, molybdenum: 4% to 7%, oxygen: a trace to 0.4%, carbon: a trace to 0.35%, and tungsten: a trace to 2%, and margins are iron and inevitable impurities.

Tungsten can not only promote formation of a reinforcing phase, such as a Laves phase and tungsten carbide, but also increase the strength of the steel mechanical part. In addition, tungsten can also delay over aging to ensure process stability. In some embodiments, tungsten and molybdenum are simultaneously added in a process of preparing the steel mechanical part.

In this embodiment of this application, a mass percentage of the tungsten is less than or equal to 2%. Because a secondary hardening effect of tungsten is relatively weak, addition of excessive tungsten is avoided to prevent strength and toughness of the steel mechanical part from being affected.

In other embodiments, the steel mechanical part further includes niobium and tungsten. For example, the steel mechanical part includes components of the following mass percentages: chromium: 7% to 11%, nickel: 2% to 7.5%, cobalt: 6% to 15%, molybdenum: 4% to 7%, oxygen: a trace to 0.4%, carbon: a trace to 0.35%, niobium: a trace to 1%, and tungsten: a trace to 2%, and margins are iron and inevitable impurities.

In another embodiment, the steel further includes boron, and a percentage of the boron is a trace to 0.01%. Boron can also refine grains, so that toughness and strength of a material are increased.

In another embodiment, the steel further includes a rare earth element, and a mass percentage of the rare earth element is a trace to 0.5%. The rare earth element can play a role of purifying a grain boundary and refining grains, improve strength and toughness of a steel material, and improve consistency of the steel material in a sintering process.

In another embodiment, the steel further includes another element, the another element includes one or more of nitrogen, rhenium, copper, aluminum, titanium, sulfur, phosphorus, hydrogen, zirconium, magnesium, calcium, yttrium, vanadium, scandium, and zinc, and a mass percentage of the another element is ≤1%.

According to a second aspect, this application provides a steel mechanical part. A material used in the steel mechanical part includes the steel described above.

In this embodiment of this application, the material used in the steel mechanical part includes the foregoing steel, so that strength of the steel mechanical part is increased. The steel mechanical part does not need to further ensure reliability of the steel mechanical part by increasing thickness of the steel mechanical part. This facilitates miniaturization of the steel mechanical part, and facilitates miniaturization of an electronic device using the steel mechanical part.

According to a third aspect, this application provides a preparation method for a steel mechanical part. The preparation method for a steel mechanical part includes:

molding a green compact of the steel mechanical part by using steel powder, where the steel powder includes components of the following mass percentages: chromium: 7% to 11%, nickel: 2% to 7.5%, cobalt: 6% to 15%, molybdenum: 4% to 7%, and iron: 50% to 80%;

sintering the green compact of the steel mechanical part to form a sintered compact of the steel mechanical part; and

performing thermal treatment on the sintered compact of the steel mechanical part.

Before the molding a green compact of the steel mechanical part by using steel powder, the preparation method for a steel mechanical part further includes: uniformly mixing the steel powder, so that the molded green compact of the steel mechanical part is homogenized.

In this embodiment of this application, the steel mechanical part molded by using the preparation method for a steel mechanical part provided in this application has characteristics that yield strength is greater than or equal to 1300 Mpa and elongation is greater than or equal to 3%; in other words, the formed steel mechanical part is characterized by both high strength and high toughness, so that the steel mechanical part is not prone to deformation or fracture under high-strength force.

In addition, based on the steel mechanical part molded by using the preparation method for a steel mechanical part provided in this application, a three-dimensional complex and precise steel mechanical part can be effectively obtained at a time. Compared with a complex and precise steel mechanical part molded by using conventional mechanical processing such as a computerized numerical control machine (CNC), additional processing is not required, so that production efficiency of preparing the complex and precise steel mechanical part is improved, costs of preparing the steel mechanical part are reduced, and large-scale production of the steel mechanical part is facilitated.

In some implementations, steel powder particles with a specific granularity requirement are prepared in a pulverization manner. A grain size of the steel powder particle is relatively small, to facilitate a molding process of the steel mechanical part. For example, a grain size of at least 90% of the steel powder is less than or equal to 35 μm, and a grain size of at most 10% of the steel powder is less than or equal to 4.5 μm. A grain size of 50% of the steel powder is in a range of 5 μm to 15 μm.

In this embodiment of this application, the grain size of 90% of the steel powder is less than or equal to 35 μm, to avoid a case in which an excessively large grain size of the steel powder is not conducive to subsequent molding of the steel powder. In addition, the grain size of at most 10% of the steel powder is less than or equal to 4.5 μm, to avoid a case in which an excessively small grain size of the steel powder is not conducive to subsequent molding of the steel powder.

In some embodiments, the steel powder further includes silicon and manganese, a mass percentage of the silicon is a trace to 0.5%, and a mass percentage of the manganese is a trace to 0.5%.

Silicon may be used as a deoxidizing agent for molten steel in a process of preparing the steel powder, and can also increase fluidity of the molten steel. In addition, a small amount of silicon is retained in a matrix, and may exist in a form of an oxide inclusion, so that matrix strength is increased. Content of silicon is defined as a trace to 0.5%.

Manganese has a deoxidization and desulfurization effect in the steel. In the process of preparing the steel powder, manganese can remove oxygen and sulfur in the molten steel, and is also an element that ensures hardenability. Similar to a role of silicon, when content of manganese is excessively high, toughness of the steel is significantly reduced. Therefore, in this application, the content of manganese is controlled as a trace to 0.5%.

In this embodiment of this application, the steel mechanical part further includes silicon and manganese, and a mass percentage of the silicon or the manganese is a trace to 0.5%, to effectively increase strength of the steel mechanical part.

In some embodiments, the steel powder further includes niobium, and a mass percentage of the niobium is a trace to 1%.

Niobium may be solid solved in the steel, and causes lattice distortion, to play a role of solid solution reinforcing, and in addition, niobium is also a carbide forming element, and can play a role of refining grains and reinforcing precipitation.

In this embodiment of this application, the steel mechanical part further includes niobium. The steel mechanical part can form Fe2Nb and NbC, and the formed Fe2Nb and the formed NbC increase the strength of the steel mechanical part. In addition, the mass percentage of the niobium is less than or equal to 1%, to avoid a case in which a brittle phase is precipitated along a grain boundary due to excessively high content of niobium, so that strength and toughness of a steel structure are increased.

In some embodiments, the steel further includes tantalum, and a mass percentage of the tantalum is a trace to 2%.

In some embodiments, the steel further includes both tantalum and niobium, a ratio of a mass percentage of the tantalum to a mass percentage of the niobium is (1 to 2):1, and the mass percentage of the tantalum plus the mass percentage of the niobium is a trace to 1.5%.

In another embodiment, the steel further includes boron, and a percentage of the boron is a trace to 0.01%. Boron can also refine grains, so that toughness and strength of a material are increased.

In another embodiment, the steel further includes a rare earth element, and a mass percentage of the rare earth element is a trace to 0.5%. The rare earth element can play a role of purifying a grain boundary and refining grains, improve strength and toughness of a steel material, and improve consistency of the steel material in a sintering process.

In another embodiment, the steel further includes another element, the another element includes one or more of nitrogen, rhenium, copper, aluminum, titanium, sulfur, phosphorus, hydrogen, zirconium, magnesium, calcium, yttrium, vanadium, scandium, and zinc, and a mass percentage of the another element is ≤1%; in other words, all other elements together are less than or equal to 1%.

In some embodiments, the steel powder further includes tungsten, and a mass percentage of the tungsten is a trace to 2%.

Tungsten can not only promote formation of a reinforcing phase, such as a Laves phase and tungsten carbide, but also increase the strength of the steel mechanical part. In addition, tungsten can also delay over aging to ensure process stability. In some embodiments, tungsten and molybdenum are simultaneously added in a process of preparing the steel mechanical part.

In this embodiment of this application, a mass percentage of the tungsten is less than or equal to 2%. Because a secondary hardening effect of tungsten is relatively weak, addition of excessive tungsten is avoided to prevent strength and toughness of the steel mechanical part from being affected.

In some embodiments, the “molding a green compact of the steel mechanical part by using steel powder” includes:

mixing the steel powder with a binder to form a paste feed;

pelleting the paste feed to form feed particles; and

molding the green compact of the steel mechanical part by using the feed particles in a pressing manner or an injection molding manner.

In this embodiment of this application, the green compact of the steel mechanical part is formed in the injection molding manner, so that not only molding efficiency is high and costs are low, but a green compact of a three-dimensional complex and precise steel mechanical part can be effectively obtained at a time. Therefore, production efficiency of the prepared complex and precise steel mechanical part is improved.

In addition, in this embodiment of this application, the binder is mixed in the steel powder, so that the formed paste feed has specific fluidity, and a mold cavity of a complex shape can be filled under the action of pressure, to mold the complex and precise steel mechanical part at a time. Therefore, production efficiency of the complex and precise steel mechanical part is improved. In this embodiment of this application, the steel powder is mixed with the binder, and the steel powder has specific fluidity, so that a disadvantage such as crack or an angle drop of the green compact of the steel mechanical part is reduced or avoided. In addition, the steel powder is mixed with the binder, and the green compact of the molded steel mechanical part has specific strength, and can maintain a shape after being removed from a mold cavity, so that deformation of the green compact of the steel mechanical part is reduced or avoided, and a yield rate of the prepared steel mechanical part is improved.

In this embodiment of this application, the green compact of the steel mechanical part is molded by using the feed particles in the injection molding manner; in other words, the green compact of the steel mechanical part is formed through metal injection molding. In another embodiment, the green compact of the steel mechanical part may also be molded by using the feed particles in the pressing manner. This is not limited in this application.

In some embodiments, after the “molding the green compact of the steel mechanical part by using the feed particles in a pressing manner or an injection molding manner”, the “molding a green compact of the steel mechanical part by using steel powder” further includes:

performing degreasing to remove the binder in the green compact of the steel mechanical part.

In some embodiments, the binder includes a thermoplastic binder.

When the thermoplastic binder is used as the binder, a subsequent degreasing process is facilitated, so that reliability of preparing the steel mechanical part is improved. For example, the binder mainly includes polyformaldehyde (POM). As a main component of the binder, the polyformaldehyde is greater than or equal to 80% in terms of a mass percentage.

In this embodiment of this application, the polyformaldehyde is used as the binder, and due to high strength of the polyformaldehyde, strength of the formed paste feed is ensured, so that the green compact of the steel mechanical part that is subsequently molded by using the paste feed has specific strength, and a disadvantage caused by demolding of the green compact of the steel mechanical part is avoided or reduced. In addition, the polyformaldehyde is suitable for catalytic decomposition of nitric acid, and a product obtained after degreasing is in a gaseous state, and degreasing efficiency is high, so that a disadvantage such as crack or deformation of the green compact of the steel mechanical part in a subsequent degreasing process is avoided.

In some embodiments, the binder in the green compact of the steel mechanical part is removed in a catalytic degreasing manner. Removing the binder through catalytic degreasing means that based on a feature that a polymer can be rapidly degraded in a specific atmosphere, the green compact of the steel mechanical part is degreased in a corresponding atmosphere, and the binder is decomposed to remove the binder.

In this embodiment of this application, the binder in the green compact of the steel mechanical part is removed in the catalytic degreasing manner, so that not only degreasing can be performed rapidly and flawlessly, but degreasing efficiency can be improved, and therefore efficiency of preparing the steel mechanical part is improved.

It may be understood that, in addition to a feature of increasing fluidity to be suitable for injection molding and maintaining a shape of a compact, the binder is further characterized by easy removal, no pollution, no toxicity, proper costs, and the like, and is conducive to a degreasing removal process.

According to a fourth aspect, this application further provides a steel mechanical part. The steel mechanical part is molded by using the preparation method described above.

In this embodiment of this application, based on the steel mechanical part molded by using the preparation method for a steel mechanical part provided in this application, a three-dimensional complex and precise steel mechanical part can be effectively obtained at a time. Compared with a complex and precise steel mechanical part molded through conventional mechanical processing, additional processing is not required, so that production efficiency of preparing the complex and precise steel mechanical part is improved, costs of preparing the steel mechanical part are reduced, and large-scale production of the steel mechanical part is facilitated. In addition, the prepared steel mechanical part has characteristics that yield strength is greater than or equal to 1300 Mpa and elongation is greater than or equal to 5%; in other words, the formed steel mechanical part is characterized by both high strength and high toughness, so that the steel mechanical part is not prone to deformation or fracture under high-strength force.

According to a fifth aspect, this application further provides an electronic device. The electronic device includes the steel mechanical part described above.

In some embodiments, the electronic device further includes a flexible display screen and a folding apparatus configured to bear the flexible display screen, the folding apparatus is configured to cause deformation of the flexible display screen, and the folding apparatus includes the steel mechanical part.

In this embodiment of this application, the steel mechanical part is applied to the folding apparatus in the electronic device, so that a risk that the steel mechanical part in the electronic device fractures after falling off from a height is reduced, and a phenomenon that a display picture of the flexible display screen is affected due to fracture of the steel mechanical part is reduced, and in addition, a risk that the folding apparatus is stuck is avoided or reduced, so that quality of the electronic device is improved. In addition, strength of the steel mechanical part is relatively high. The steel mechanical part does not need to ensure reliability of the steel mechanical part by increasing thickness, and this facilitates miniaturization of the folding apparatus, and facilitates miniaturization of the electronic device.

### BRIEF DESCRIPTION OF DRAWINGS

To describe technical solutions in embodiments of this application or in the background more clearly, the following describes the accompanying drawings used in embodiments of this application or in the background.

FIG. 1 is a schematic diagram of a structure of an electronic device in one state according to an embodiment of this application;

FIG. 2 is a schematic diagram of a structure of an electronic device in another state according to an embodiment of this application;

FIG. 3 is a schematic flowchart of a preparation method for a steel mechanical part according to an embodiment of this application; and

FIG. 4 is a schematic flowchart of step S120 in FIG. 3.

### DESCRIPTION OF EMBODIMENTS

The following describes embodiments of this application with reference to the accompanying drawings in embodiments of this application.

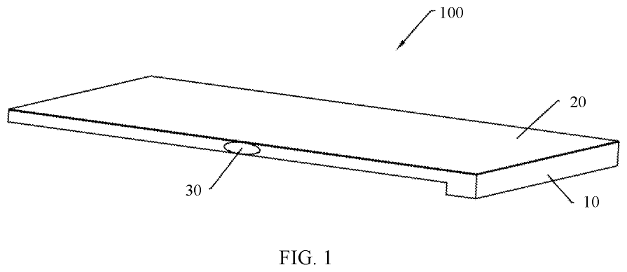

FIG. 1 is a schematic diagram of a structure of an electronic device 100 in one state according to an embodiment of this application. The electronic device 100 may be a device such as a mobile phone, a tablet computer, an electronic reader, a notebook computer, a vehicle-mounted device, a wearable device, or an electronic newspaper that can be curled and folded. In this embodiment of this application, as an example for description, the electronic device 100 is a mobile phone.

As shown in FIG. 1, in some embodiments, the electronic device 100 includes a housing 10, a flexible display screen 20, and a folding apparatus 30. The folding apparatus 30 is mounted on the housing 10. The flexible display screen 20 is configured to display a picture. The folding apparatus 30 is configured to drive the flexible display screen 20 to be deformed. For example, the folding apparatus 30 is connected to the flexible display screen 20, and is configured to drive the flexible display screen 20 to be folded or unfolded. The folding apparatus 30 includes a rotating shaft, and the rotating shaft can rotate under the action of driving force, to drive the flexible display screen 20 to be bent.

A type of the flexible display screen 20 and a type of the folding apparatus 30 are not limited in this application. A person skilled in the art may select the type of the flexible display screen 20 and the type of the folding apparatus 30 based on an actual requirement. The flexible display screen 20 is made of a soft material and is a flexible and bendable display panel with a display function. Shapes and thickness of the flexible display screen 20 and the folding apparatus 30 in FIG. 1 are merely examples, and are not limited in this application.

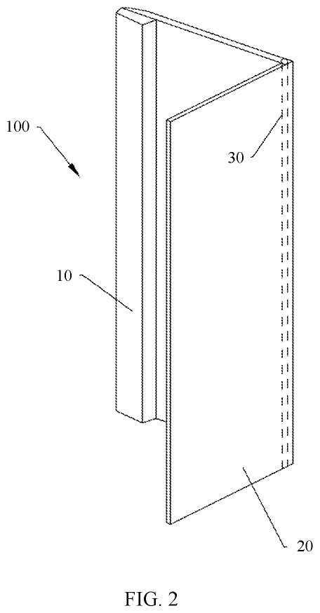

Refer to both FIG. 1 and FIG. 2. FIG. 2 is a schematic diagram of a structure of an electronic device 100 in another state according to an embodiment of this application. Under the action of driving force, the folding apparatus 30 can rotate, to drive the flexible display screen 20 to be bent or unfolded. As shown in FIG. 1, in one state, the electronic device 100 is in an unfolded state, and in this case, the flexible display screen 20 is located on a same plane. As shown in FIG. 2, in another state, the electronic device 100 is in a folded state, and in this case, a partial structure of the flexible display screen 20 and the other partial structure of the flexible display screen 20 are located on different planes. The electronic device 100 provided in this application can be correspondingly folded or unfolded based on different use scenarios, and the electronic device 100 presents different forms to meet different requirements of a user.

The folding apparatus 30 includes a steel mechanical part. The steel mechanical part is a mechanical part with a specific appearance shape. For example, the steel mechanical part may be but is not limited to a complex force-bearing mechanical part such as a rotating shaft, a gear, a slider, a chute, or a connecting rod in the folding apparatus 30. The steel mechanical part has specific strength, to ensure mechanical strength of the folding apparatus 30, and avoid deformation of the folding apparatus 30 due to force bearing, so that reliability of the electronic device 100 is ensured. A material used in the steel mechanical part includes steel. The steel mechanical part may be obtained through one-time molding by using steel powder, or may be molded into a steel mechanical part with a specific shape by processing sheet steel. This is not limited in this application.

In a conventional technology, a steel mechanical part in a folding apparatus is prone to deformation and is even in a risk of fracture when bearing relatively large force. Consequently, not only the folding apparatus is stuck, but the electronic device cannot switch between a folded state and an unfolded state. In addition, a fractured steel mechanical part may press against a flexible display screen, and affects a display picture of the flexible display screen, and consequently, quality of the electronic device is affected. For example, in the conventional technology, a material used in the folding apparatus is 17-4 PH or 420 w. Strength of the material is insufficient, and toughness is poor. When the electronic device falls off from a height, the steel mechanical part in the folding apparatus easily fractures, and therefore a service life of the electronic device is affected.

In the conventional technology, the steel mechanical part in the electronic device is in a risk of fracture. Therefore, this application provides a steel mechanical part with relatively high strength and relatively high elongation, to reduce a risk of fracture and failure of the steel mechanical part in a process in which the electronic device 100 falls off. In addition, strength of the steel mechanical part is relatively high, and the steel mechanical part does not need to ensure reliability of the steel mechanical part by increasing thickness. Therefore, miniaturization of the steel mechanical part is facilitated, and miniaturization of the electronic device 100 is facilitated. For example, yield strength of the steel mechanical part provided in this application is greater than or equal to 1300 Mpa, and elongation is greater than or equal to 3%.

The yield strength is a yield limit of a metal material when a yield phenomenon occurs, that is, stress that resists micro plastic deformation. It may be understood that, greater yield strength of the steel mechanical part leads to greater mechanical strength of the steel mechanical part. The elongation (δ) is an indicator for describing plastic performance of a material. An elongation value is a percentage of a ratio of a total deformation length obtained after a sample is stretched and fractures to an original length.

In this embodiment of this application, the yield strength of the steel mechanical part is greater than or equal to 1300 Mpa, so that mechanical structure strength of a folding apparatus 30 using the steel mechanical part is relatively high. Therefore, a risk that the electronic device 100 fractures after falling off from a height is reduced or avoided, and reliability of the folding apparatus 30 is improved, so that quality of the electronic device 100 is improved.

In some embodiments, the yield strength of the steel mechanical part is less than or equal to 2000 Mpa, and the elongation is less than or equal to 12%. It may be understood that, greater yield strength of the steel mechanical part and greater elongation of the steel mechanical part lead to a more difficult method for preparing the steel mechanical part.

In this embodiment of this application, the yield strength of the steel mechanical part is less than or equal to 2000 Mpa, and the elongation is less than or equal to 12%. Therefore, while it is ensured that the steel mechanical part has relatively high mechanical strength, difficulty in the method for preparing the steel mechanical part is reduced, so that production costs of the steel mechanical part are reduced.

In this embodiment of this application, as an example for description, the steel mechanical part is the folding apparatus 30 of the electronic device 100. In another embodiment, the steel mechanical part may alternatively be another mechanical part of a relatively complex shape in the electronic device 100, such as a gear. This is not limited in this application.

In another embodiment, the steel mechanical part may alternatively be a middle frame or a rear cover of the electronic device 100. This is not limited in this application. For example, the steel mechanical part is a middle frame of the electronic device 100. Because the steel mechanical part has relatively great yield strength and is not prone to deformation, when the electronic device 100 falls off from a height, the middle frame of the electronic device 100 is not prone to deformation. Therefore, a risk of deformation of an appearance of the electronic device 100 is reduced, so that a beautiful appearance of the electronic device 100 is ensured.

In some embodiments, the steel mechanical part includes components of the following mass percentages: chromium (Cr): 7% to 11%, nickel (Ni): 2% to 7.5%, cobalt (Co): 6% to 15%, molybdenum (Mo): 4% to 7%, oxygen (O): a trace to 0.4%, carbon (C): a trace to 0.35%, and iron: 50% to 80%.

A range A to B represents end points A and B and any value between A and B. Chemically, a trace means content less than one millionth in a substance. It may be understood that a trace chemically means that content of a substance component is very small, and there is merely a trace of the component. A meaning of the word trace varies with the development of a trace analysis technology. In this embodiment of this application, lower limits of content of oxygen and content of carbon are not limited.

Carbon is one of the most common elements in the steel and one of austenite stabilized elements. In addition, carbon can improve hardenability of the steel. In a Fe—Cr—Ni—Co—Mo system, MC (such as Mo2C or W2C) carbide can also be generated to increase matrix strength. Excessive carbon is combined with chromium in the matrix to form a series of complex carbide, and this makes it difficult to control a structure. Therefore, content of carbon is defined as less than or equal to 0.35%.

Chromium plays a decisive role in corrosion resistance of the steel. In this embodiment of this application, a mass percentage of the chromium is less than or equal to 11%, to avoid a case in which strength of the steel mechanical part is relatively low because the steel mechanical part forms ferrite due to excessively high content of chromium. In addition, the mass percentage of the chromium is greater than or equal to 7%, to avoid a case in which strength of the steel mechanical part is reduced because excessively low content of chromium reduces an Ms point of the steel and suppresses precipitation of a Laves phase. The Laves phase is an intermetallic compound whose chemical formula is mainly a closepacked cubic or hexagonal structure of an AB2 type. The Laves phase is a second phase in a steel material. When the second phase is evenly distributed in a matrix phase by using fine and dispersed particles, a significant reinforcing effect is generated. This reinforcing effect is referred to as second phase reinforcing.

Nickel is an important austenite stabilized element in the steel and also an important tough element in the steel. In this embodiment of this application, a mass percentage of the nickel is greater than or equal to 2%, so that a cleavage fracture resistance capability of a martensitic structure in the steel mechanical part is improved, and sufficient toughness of the steel mechanical part is ensured. In addition, the mass percentage of the nickel is less than or equal to 7.5%, to avoid a case in which austenite is prevented from being converted into martensite in a quenching processing process due to existence of excessive nickel, so that strength of the steel mechanical part is increased.

Cobalt promotes formation of the austenite in a process of preparing the steel, and helps improve toughness of the steel mechanical part. In addition, cobalt can delay recovery of a dislocation substructure of the martensite, maintain high dislocation density of a martensite lath, and promote formation of a precipitate phase. Cobalt is an austenite stabilized element. When content of cobalt is excessively high, stabilized austenite is formed in an alloy, and cannot be converted to martensite in a quenching process, and consequently, a matrix is prevented from achieving high strength. Therefore, content of cobalt is defined as 6% to 15%.

Mmolybdenum can promote formation of a reinforcing phase, such as the Laves phase and molybdenum carbide, so that strength of the steel mechanical part is increased. In addition, molybdenum is a ferrite stabilized element, and if there is excessive molybdenum, excessive austenite is generated in an alloy and is converted into stable ferrite, and consequently, matrix strength is reduced. Therefore, content of molybdenum is defined as 4% to 7%.

Oxygen is easy to form inclusions in the steel, and a small amount of oxide inclusions can increase the matrix strength in a diffused state. Due to a special powder preparation and sintering process of molding, content of oxygen may be strictly controlled from a powder preparation and sintering process, and the content is defined as a trace to 0.4%.

In this embodiment of this application, a mass percentage of each component in the steel mechanical part is limited, so that the steel mechanical part can be reinforced by relying on a Fe—Co—Ni—Cr—Mo phase, a Fe—Co—Cr—Mo phase, and carbide (such as Mo2C or W2C), and therefore yield strength of the formed steel mechanical part is greater than or equal to 1300 Mpa, and elongation is greater than or equal to 3%; in other words, the formed steel mechanical part is characterized by both high strength and high toughness, and the steel mechanical part is not prone to deformation or fracture under high-strength force. The mass percentage of each component in the steel mechanical part is different, and components of the reinforcing phase are also different; in other words, a formed Fe—Co—Ni—Cr—Mo phase, Fe—Co—Cr—Mo phase, or carbide is different. The reinforcing phase may be but is not limited to (Fe, Co, Ni)17Cr8Mo18, (Fe, Co)15Cr8Mo4, (Fe, Co)16Cr8Mo18, or the like.

In addition, in this embodiment of this application, content of carbon in the steel mechanical part is relatively low (less than or equal to 0.35%). In a process of preparing the steel mechanical part, for example, in a sintering process, it is easy to perform control, so that difficulty in producing the steel mechanical part is reduced, production costs of the steel mechanical part are reduced, and production quality of the steel mechanical part is ensured.

The steel mechanical part provided in this application is further described below by using a plurality of embodiments.

### Embodiment 1

The steel mechanical part includes components of the following mass percentages: chromium (Cr): 7% to 11%, nickel (Ni): 2% to 7.5%, cobalt (Co): 6% to 15%, molybdenum (Mo): 4% to 7%, oxygen (O): a trace to 0.4%, carbon (C): a trace to 0.35%, silicon (Si): a trace to 0.5%, and manganese (Mn): a trace to 0.5%, and margins are iron and inevitable impurities.

Silicon may be used as a deoxidizing agent for molten steel in a process of preparing steel powder, and can also increase fluidity of the molten steel. In addition, a small amount of silicon is retained in a matrix, and may exist in a form of an oxide inclusion, so that matrix strength is increased. Content of silicon is defined as a trace to 0.5%.

Manganese has a deoxidization and desulfurization effect in the steel. In the process of preparing the steel powder, manganese can remove oxygen and sulfur in the molten steel, and is also an element that ensures hardenability. Similar to a role of silicon, when content of manganese is excessively high, toughness of the steel is significantly reduced. Therefore, in this application, the content of manganese is controlled as a trace to 0.5%.

In this embodiment of this application, the steel mechanical part further includes silicon and manganese, and a mass percentage of the silicon or the manganese is a trace to 0.5%, to effectively increase strength of the steel mechanical part.

Table 1 is a table of component content of the steel mechanical part provided in this application in implementations of Embodiment 1. Table 1 reflects yield strength and elongation corresponding to content of each component in the steel mechanical part in different implementations.

TABLE 1

| | | | | | | | | | | | | Performance | |
|---|---|---|---|---|---|---|---|---|---|---|---|---|---|
| | | | | | | | | | | | | Yield | |
| | Component | | | | | | | | | | | strength/ | Elongation/ |
| Implementation | O % | C % | Cr % | Ni % | Co % | Mo % | Si % | Mn % | Nb % | W % | Fe % | Mpa | % |
| 1 | 0.07 | 0.007 | 8.22 | 6.13 | 9.08 | 4.53 | 0.23 | 0.06 | 0 | 0 | Margin | 1610 | 6.4 |
| 2 | 0.005 | 0.004 | 9.58 | 7.44 | 10.25 | 5.99 | 0.22 | 0.18 | 0 | 0 | Margin | 1560 | 6.69 |
| 3 | 0.07 | 0.004 | 8.3 | 3.2 | 13.6 | 6.3 | 0.22 | 0.18 | 0 | 0 | Margin | 1520 | 5.1 |
| 4 | 0.006 | 0.002 | 8.26 | 6.5 | 7.4 | 6.1 | 0.35 | 0.38 | 0 | 0 | Margin | 1510 | 5.5 |
| 5 | 0.002 | 0.002 | 9.52 | 3.73 | 13.7 | 5.56 | 0.08 | 0.16 | 0 | 0 | Margin | 1570 | 5.3 |

In some embodiments, based on that content of cobalt is in a range of 6% to 15% and content of nickel is in a range of 2% to 7.5%, when the content of cobalt is relatively high, the content of nickel is correspondingly reduced; or when the content of nickel is relatively high, the content of cobalt is correspondingly reduced.

In this embodiment, the content of nickel is properly increased, and this helps improve toughness of the steel mechanical part, and excessive nickel leads to a decrease in strength of the steel mechanical part. When the content of nickel is relatively small, the content of cobalt is increased, so that precipitation of the reinforcing phase is promoted, and the strength of the steel mechanical part is increased.

### Embodiment 2

In Embodiment 2, the steel mechanical part further includes niobium (Nb). A mass percentage of the niobium is a trace to 1%. It may be understood that a specific lower limit of niobium is not limited in this application. The steel mechanical part in Embodiment 2 includes the components in Embodiment 1. In other words, in Embodiment 2, the steel mechanical part includes components of the following mass percentages: chromium: 7% to 11%, nickel: 2% to 7.5%, cobalt: 6% to 15%, molybdenum: 4% to 7%, oxygen: a trace to 0.4%, carbon: a trace to 0.35%, and niobium: a trace to 1%, and margins are iron and inevitable impurities.

Niobium may be solid solved in the steel, and causes lattice distortion, to play a role of solid solution reinforcing, and in addition, niobium is also a carbide forming element, and can play a role of refining grains and reinforcing precipitation. Roles of tantalum and niobium are similar in the steel. Therefore, in a material preparation process, tantalum and niobium may replace each other in a specific ratio, and a replacement ratio of tantalum and niobium is approximately (1 to 2):1.

In this embodiment of this application, the steel mechanical part further includes niobium. The steel mechanical part can form Fe2Nb and NbC, and the formed Fe2Nb and the formed NbC increase the strength of the steel mechanical part. In addition, the mass percentage of the niobium is less than or equal to 1%, to avoid a case in which a brittle phase is precipitated along a grain boundary due to excessively high content of niobium, so that strength and toughness of a steel structure are increased.

Table 2 is a table of component content of the steel mechanical part provided in this application in implementations of Embodiment 2. Table 2 reflects yield strength and elongation corresponding to content of each component in the steel mechanical part in different implementations.

TABLE 2

| | | | | | | | | | | | | Performance | |
|---|---|---|---|---|---|---|---|---|---|---|---|---|---|
| | | | | | | | | | | | | Yield | |
| | Component | | | | | | | | | | | strength/ | Elongation/ |
| Implementation | O % | C % | Cr % | Ni % | Co % | Mo % | Si % | Mn % | Nb % | W % | Fe % | Mpa | % |
| 1 | 0.27 | 0.003 | 8.13 | 6.54 | 9.52 | 4.28 | 0.23 | 0.06 | 0.35 | 0 | Margin | 1690 | 5.1 |
| 2 | 0.1 | 0.01 | 10.25 | 7.05 | 10.3 | 5.7 | 0.22 | 0.13 | 0.42 | 0 | Margin | 1560 | 7.8 |

### Embodiment 3

In Embodiment 3, the steel mechanical part further includes tungsten (W). A mass percentage of the tungsten is a trace to 2%. It may be understood that a specific lower limit of tungsten is not limited in this application. The steel mechanical part in Embodiment 3 includes the components of the steel mechanical part in the foregoing embodiment. For example, in Embodiment 3, the steel mechanical part includes components of the following mass percentages: chromium: 7% to 11%, nickel: 2% to 7.5%, cobalt: 6% to 15%, molybdenum: 4% to 7%, oxygen: a trace to 0.4%, carbon: a trace to 0.35%, and tungsten: a trace to 2%, and margins are iron and inevitable impurities.

Tungsten can not only promote formation of a reinforcing phase, such as a Laves phase and tungsten carbide, but also increase the strength of the steel mechanical part. In addition, tungsten can also delay over aging to ensure process stability. In some embodiments, tungsten and molybdenum are simultaneously added in a process of preparing the steel mechanical part.

In this embodiment of this application, a mass percentage of the tungsten is less than or equal to 2%. Because a secondary hardening effect of tungsten is relatively weak, addition of excessive tungsten is avoided to prevent strength and toughness of the steel mechanical part from being affected.

Table 3 is a table of component content of the steel mechanical part provided in this application in implementations of Embodiment 3. Table 3 reflects yield strength and elongation corresponding to content of each component in the steel mechanical part in different implementations.

TABLE 3

| | | | | | | | | | | | | Performance | |
|---|---|---|---|---|---|---|---|---|---|---|---|---|---|
| | | | | | | | | | | | | Yield | |
| | Component | | | | | | | | | | | strength/ | Elongation/ |
| Implementation | O % | C % | Cr % | Ni % | Co % | Mo % | Si % | Mn % | Nb % | W % | Fe % | Mpa | % |
| 1 | 0.07 | 0.21 | 9.9 | 2.1 | 14.6 | 5.43 | 0.22 | 0.11 | 0 | 1.17 | Margin | 1720 | 5.8 |
| 2 | 0.05 | 0.16 | 8.76 | 2.46 | 13.2 | 5.23 | 0.22 | 0.11 | 0 | 1.26 | Margin | 1690 | 5.5 |

### Embodiment 4

In Embodiment 4, the steel mechanical part further includes niobium and tungsten. A mass percentage of the niobium is a trace to 1%, and a mass percentage of the tungsten is a trace to 2%. The steel mechanical part in Embodiment 4 includes the components of the steel mechanical part in the foregoing embodiment. For example, in Embodiment 4, the steel mechanical part includes components of the following mass percentages: chromium: 7% to 11%, nickel: 2% to 7.5%, cobalt: 6% to 15%, molybdenum: 4% to 7%, oxygen: a trace to 0.4%, carbon: a trace to 0.35%, niobium: a trace to 1%, and tungsten: a trace to 2%, and margins are iron and inevitable impurities.

Table 4 is a table of component content of the steel mechanical part provided in this application in implementations of Embodiment 4. Table 4 reflects yield strength and elongation corresponding to content of each component in the steel mechanical part.

TABLE 4

| | | | | | | | | | | | | Performance | |
|---|---|---|---|---|---|---|---|---|---|---|---|---|---|
| | | | | | | | | | | | | Yield | |
| | Component | | | | | | | | | | | strength/ | Elongation/ |
| Implementation | O % | C % | Cr % | Ni % | Co % | Mo % | Si % | Mn % | Nb % | W % | Fe % | Mpa | % |
| 1 | 0.003 | 0.002 | 8.15 | 3.72 | 13.78 | 5.79 | 0.18 | 0.07 | 0.34 | 0.21 | Margin | 1510 | 7.6 |
| 2 | 0.005 | 0.007 | 8.36 | 6.83 | 7.18 | 5.81 | 0.14 | 0.09 | 0.26 | 1.47 | Margin | 1562 | 5.6 |
| 3 | 0.12 | 0.03 | 9.02 | 3.88 | 12.36 | 5.33 | 0.24 | 0.17 | 0.11 | 1.16 | Margin | 1620 | 5.1 |
| 4 | 0.11 | 0.09 | 9.44 | 3.08 | 14.3 | 5.4 | 0.23 | 0.16 | 0.12 | 0.77 | Margin | 1510 | 6.7 |
| 5 | 0.12 | 0.05 | 7.11 | 6.08 | 8.88 | 5.38 | 0.21 | 0.09 | 0.11 | 0.14 | Margin | 1630 | 6.6 |
| 6 | 0.09 | 0.06 | 10.77 | 3.32 | 9.66 | 6.05 | 0.26 | 0.18 | 0.16 | 0.44 | Margin | 1510 | 5.2 |
| 7 | 0.04 | 0.32 | 9.4 | 3.15 | 14.2 | 5.6 | 0.21 | 0.07 | 0.13 | 1.86 | Margin | 1760 | 6.2 |
| 8 | 0.03 | 0.27 | 8.8 | 3.62 | 13.48 | 6.1 | 0.19 | 0.08 | 0.09 | 0.89 | Margin | 1680 | 6.1 |
| 9 | 0.05 | 0.16 | 8.86 | 3.75 | 12.46 | 6.76 | 0.22 | 0.09 | 0.11 | 0.76 | Margin | 1650 | 6.3 |

In some embodiments, a mass percentage of the chromium is 7% to 9%, and a mass percentage of the cobalt is 7% to 14%.

This application further provides steel. The steel provided in this application may be a steel mechanical part with a specific complex shape, or may be unmolded sheet steel. This is not limited in this application. Steel is used in the steel mechanical part. Mass percentages of components in the steel are the same as the mass percentages of the components in the foregoing steel mechanical part. It may be understood that the foregoing steel mechanical part is a presentation form of the steel. For each mass percentage in the steel in different embodiments, refer to each mass percentage in the foregoing steel mechanical part in any one of Embodiment 1 to Embodiment 4. Details are not described in this application. For example, the steel includes components of the following mass percentages: chromium: 7% to 11%, nickel: 2% to 7.5%, cobalt: 6% to 15%, molybdenum: 4% to 7%, oxygen: a trace to 0.4%, and carbon: a trace to 0.35%, and margins are iron and inevitable impurities. In some embodiments, the steel may further include niobium with a mass percentage of a trace to 1%. In other embodiments, the steel may further include tungsten with a mass percentage of a trace to 2%.

This application further provides a preparation method for a steel mechanical part. In a conventional technology, a steel mechanical part with a relatively complex structure is generally molded by using a computerized numerical control machine (CNC). However, this molding manner is low in efficiency and high in costs. The computerized numerical control machine is an automated machine equipped with a program control system and is used for processing parts in a large scale. Metal injection molding (MIM) is a new powder metallurgy near-net molding technology that extends from the plastic injection molding industry. Based on a metal injection molding technology, products of various complex shapes can be produced, and production costs are relatively low, and the products are widely used in a steel mechanical part with a relatively complex production structure.

However, in the conventional technology, some steel mechanical parts in an electronic device, such as a rotating shaft component in a folding mobile phone, are molded through metal injection. However, because strength of the molded steel mechanical part is limited and elongation is relatively low, a folding apparatus is prone to deformation and is even in a risk of fracture when bearing relatively large force. Consequently, not only the folding apparatus is stuck, but the electronic device cannot switch between a folded state and an unfolded state. In addition, a fractured steel mechanical part may press against a flexible display screen, and affects a display picture of the flexible display screen, and consequently, quality of the electronic device is affected. For example, in the conventional technology, one of materials used by the steel mechanical part in the folding apparatus through molding is 17-4 PH. Insufficient strength of this material restricts design freedom of a product, and reliability needs to be ensured by increasing thickness of the product. Another type of material is 420 w. This material is not strong enough and is poor in toughness. In addition, excessively high content of carbon makes it difficult to control a subsequent sintering process, production is very difficult, and production and product quality are affected.

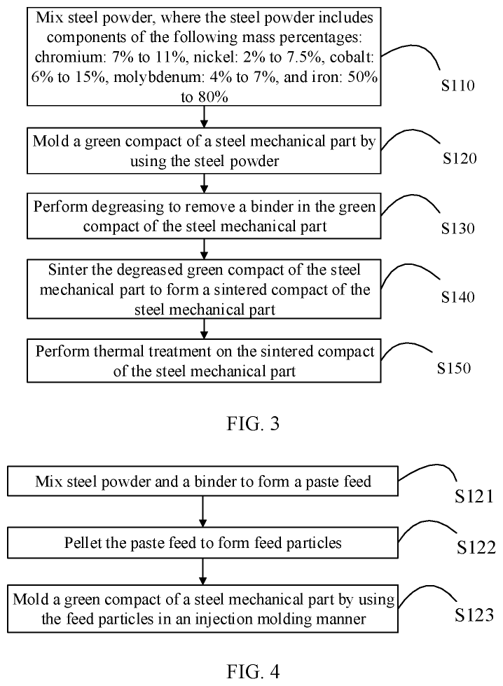

FIG. 3 is a schematic flowchart of a preparation method for a steel mechanical part according to this application. The preparation method for a steel mechanical part provided in this application includes but is not limited to preparing the foregoing steel mechanical part. The foregoing steel mechanical part may be obtained by using the preparation method for a steel mechanical part provided in this application, or may be obtained by using another method.

The preparation method for a steel mechanical part includes the following steps.

S110: Mix steel powder, where the steel powder includes components of the following mass percentages: chromium: 7% to 11%, nickel: 2% to 7.5%, cobalt: 6% to 15%, molybdenum: 4% to 7%, and iron: 50% to 80%.

In some embodiments, the steel powder further includes carbon and oxygen. Content of carbon and content of oxygen in the steel powder are not limited in this application, and a person skilled in the art may select the content of carbon and the content of oxygen based on an actual requirement. For example, the content of carbon is less than or equal to 0.35%, and the content of oxygen is less than or equal to 0.45%.

In some implementations, steel powder particles with a specific granularity requirement are prepared in a pulverization manner. A grain size of the steel powder particle is relatively small, to facilitate a molding process of the steel mechanical part. For example, a grain size of at least 90% of the steel powder is less than or equal to 35 μm, and a grain size of at most 10% of the steel powder is less than or equal to 4.5 μm. A grain size of 50% of the steel powder is in a range of 5 μm to 15 μm.

In this embodiment of this application, the grain size of 90% of the steel powder is less than or equal to 35 μm, to avoid a case in which an excessively large grain size of the steel powder is not conducive to subsequent molding of the steel powder. In addition, the grain size of at most 10% of the steel powder is less than or equal to 4.5 μm, to avoid a case in which an excessively small grain size of the steel powder is not conducive to subsequent molding of the steel powder.

In some embodiments, the steel powder further includes silicon and manganese, a mass percentage of the silicon is a trace to 0.5%, and a mass percentage of the manganese is a trace to 0.5%.

Silicon may be used as a deoxidizing agent for molten steel in a process of preparing the steel powder, and can also increase fluidity of the molten steel. In addition, a small amount of silicon is retained in a matrix, and may exist in a form of an oxide inclusion, so that matrix strength is increased. Content of silicon is defined as a trace to 0.5%. Manganese has a deoxidization and desulfurization effect in the steel. In the process of preparing the steel powder, manganese can remove oxygen and sulfur in the molten steel, and is also an element that ensures hardenability. Similar to a role of silicon, when content of manganese is excessively high, toughness of the steel is significantly reduced. Therefore, in this application, the content of manganese is controlled as a trace to 0.5%.

In this embodiment of this application, the steel mechanical part further includes silicon and manganese, and a mass percentage of the silicon or the manganese is a trace to 0.5%, to effectively increase strength of the prepared steel mechanical part.

In some embodiments, the steel powder further includes niobium, and a mass percentage of the niobium is a trace to 1%. Niobium may be solid solved in the steel, and causes lattice distortion, to play a role of solid solution reinforcing, and in addition, niobium is also a carbide forming element, and can play a role of refining grains and reinforcing precipitation.

In this embodiment of this application, the steel powder further includes niobium, so that the prepared steel mechanical part can form Fe2Nb and NbC, and the formed Fe2Nb and the formed NbC increase strength of the steel mechanical part. In addition, the mass percentage of the niobium is less than or equal to 1%, to avoid a case in which a brittle phase is precipitated along a grain boundary due to excessively high content of niobium, so that strength and toughness of the prepared steel mechanical part are increased.

In some embodiments, the steel powder further includes tungsten, and a mass percentage of the tungsten is a trace to 2%.

Tungsten can not only promote formation of a reinforcing phase, such as a Laves phase and tungsten carbide, but also increase the strength of the prepared steel mechanical part. In addition, tungsten can also delay over aging to ensure process stability. In some embodiments, tungsten and molybdenum are simultaneously added in a process of preparing the steel mechanical part.

In this embodiment of this application, a mass percentage of the tungsten is less than or equal to 2%. Because a secondary hardening effect of tungsten is relatively weak, addition of excessive tungsten is avoided to prevent strength and toughness of the prepared steel mechanical part from being affected.

S120: Mold a green compact of the steel mechanical part by using the steel powder.

Refer to both FIG. 3 and FIG. 4. FIG. 4 is a schematic flowchart of step S120 in FIG. 3. In some implementations, the “molding a green compact of the steel mechanical part by using the steel powder” includes the following steps.

S121: Mix the steel powder and a binder to form a paste feed.

The binder is mixed in the steel powder, so that the formed paste feed has specific fluidity, and a mold cavity of a complex shape can be filled under the action of pressure, to mold a complex and precise steel mechanical part at a time. Therefore, production efficiency of the complex and precise steel mechanical part is improved.

In this embodiment of this application, the steel powder is mixed with the binder, so that not only fluidity of the steel powder is increased, but the steel powder also has specific strength. Therefore, subsequent transfer and transportation operations are facilitated, and a product shape is maintained, so that a yield rate of the steel mechanical part is improved.

In some embodiments, the steel powder is mixed with the binder based on a target ratio, and then added to a mixer for mixing to form a uniform paste feed. The steel powder and the binder are mixed under a joint action of a heat effect and shear force. Therefore, temperature of a mixing material cannot be excessively high, to avoid a phenomenon that the binder is decomposed or the steel power and the binder are separated due to excessively low viscosity.

A ratio of the steel powder to the binder and a mixing condition of the mixer are not limited in this application. A person skilled in the art may select the ratio of the steel powder to the binder and the mixing condition of the mixer based on an actual requirement. For example, the steel powder and the binder are mixed based on a volume ratio of 62:38. Parameters of mixtures in the mixer are as follows: Temperature is 170° C. to 210° C., time is 2 h to 4 h, and a rotation speed of a blade is 15 r/min to 30 r/min.

In some embodiments, the binder includes a thermoplastic binder. When the thermoplastic binder is used as the binder, a subsequent degreasing process is facilitated, so that reliability of preparing the steel mechanical part is improved. For example, the binder mainly includes polyformaldehyde (POM). As a main component of the binder, the polyformaldehyde is greater than or equal to 80% in terms of a mass percentage.

In this embodiment of this application, the polyformaldehyde is used as the binder, and due to high strength of the polyformaldehyde, strength of the formed paste feed is ensured, so that the green compact of the steel mechanical part that is subsequently molded by using the paste feed has specific strength, and a disadvantage caused by demolding of the green compact of the steel mechanical part is avoided or reduced. In addition, the polyformaldehyde is suitable for catalytic decomposition of nitric acid, and a product obtained after degreasing is in a gaseous state, and degreasing efficiency is high, so that a disadvantage such as crack or deformation of the green compact of the steel mechanical part in a subsequent degreasing process is avoided.

In some embodiments, the binder further includes ethylene vinyl acetate (EVA), polyethylene (PE), ceresine wax (CW), and stearic acid (SA).

A person skilled in the art may select proportions of components in the binder based on an actual process requirement. In some embodiments, mass percentages of components in the binder are as follows: polyformaldehyde: 80% to 95%, ethylene vinyl acetate: 0.5% to 1.5%, polyethylene: 2% to 9%, CW: 1% to 3%, and SA: 0.5% to 1.5%. For example, polyformaldehyde:ethylene vinyl acetate:polyethylene:CW:SA=89:1:5:2:1. Specific content of each component in the binder is not limited in this application.

S122: Pellet the paste feed to form feed particles.

The paste feed may be pelleted by using a pelletizer to form the feed particles. For example, after the paste feed is transferred into the pelletizer, a screw of the pelletizer squeezes the gradually cooled paste feed through a die head, and a rotary blade cuts the strip-shaped feed into cylindrical particles of a length of 2 mm to 3 mm, to obtain feed particles that can be directly used for molding.

S123: Mold the green compact of the steel mechanical part by using the feed particles in an injection molding manner.

The feed particles are added to a hopper of an injection molding machine, and are molded under specific temperature and pressure through injection molding to obtain the green compact of the steel mechanical part. A condition such as temperature or pressure of injection molding is not limited in this application, and a person skilled in the art may perform selection based on an actual situation. For example, the temperature of injection molding is 170° C. to 220° C., and the pressure of injection molding is 150 MPa to 200 MPa.

In this embodiment of this application, the green compact of the steel mechanical part is formed in the injection molding manner, so that not only molding efficiency is high and costs are low, but a green compact of a three-dimensional complex and precise steel mechanical part can be effectively obtained at a time. Therefore, production efficiency of the prepared complex and precise steel mechanical part is improved.

In addition, in this embodiment of this application, the steel powder is mixed with the binder, and the steel powder has specific fluidity, so that a disadvantage such as crack or an angle drop of the green compact of the steel mechanical part is reduced or avoided. In addition, the steel powder is mixed with the binder, and the green compact of the molded steel mechanical part has specific strength, and can maintain a shape after being removed from a mold cavity, so that deformation of the green compact of the steel mechanical part is reduced or avoided, and a yield rate of the prepared steel mechanical part is improved.

In this embodiment of this application, the green compact of the steel mechanical part is molded by using the feed particles in the injection molding manner; in other words, the green compact of the steel mechanical part is formed through metal injection molding (metal injection molding, MIM). In another embodiment, the green compact of the steel mechanical part may also be molded by using the feed particles in the pressing manner. This is not limited in this application.

S130: Perform degreasing to remove the binder in the green compact of the steel mechanical part.

In some embodiments, the binder in the green compact of the steel mechanical part is removed in a catalytic degreasing manner. Removing the binder through catalytic degreasing means that based on a feature that a polymer can be rapidly degraded in a specific atmosphere, the green compact of the steel mechanical part is degreased in a corresponding atmosphere, and the binder is decomposed to remove the binder.

In this embodiment of this application, the binder in the green compact of the steel mechanical part is removed in the catalytic degreasing manner, so that not only degreasing can be performed rapidly and flawlessly, but degreasing efficiency can be improved, and therefore efficiency of preparing the steel mechanical part is improved.

It may be understood that, in addition to a feature of increasing fluidity to be suitable for injection molding and maintaining a shape of a compact, the binder is further characterized by easy removal, no pollution, no toxicity, proper costs, and the like, and is conducive to a degreasing removal process.

In this embodiment of this application, as an example for description, the binder is removed through catalytic degreasing. In another embodiment, another degreasing manner such as solvent degreasing may also be used. This is not limited in this application.

In some implementations, the green compact of the steel mechanical part is placed on an alumina ceramic plate, placed in a catalytic degreasing furnace, and catalyzed to be degreased in a specific condition. A condition such as time, temperature, or a specific atmosphere for degreasing is not limited in this application, and a person skilled in the art may select a degreasing condition based on an actual requirement. For example, the temperature of catalytic degreasing is set to 110° C. to 130° C., an inlet amount of fuming nitric acid is 0.5 g/min to 3.5 g/min, and time is 2 h to 4 h.

S140: Sinter the degreased green compact of the steel mechanical part to form a sintered compact of the steel mechanical part.

The green compact of the steel mechanical part needs to be sintered in an atmosphere with protective gas such as Ar, H2, or vacuum, to avoid introducing impurities into air. In this application, a condition such as temperature or time for sintering the green compact of the steel mechanical part is not limited, and a person skilled in the art may set a sintering condition based on an actual requirement. For example, sintering temperature is 1200° C. to 1400° C., and sintering time is 1.5 h to 4 h.

In this embodiment of this application, the green compact of the steel mechanical part is sintered, so that holes in the green compact of the steel mechanical part can be reduced or eliminated, to densify the green compact of the steel mechanical part. Therefore, the formed sintered compact of the steel mechanical part reaches full densification or nearly full densification, so that strength of the steel mechanical part is increased.

In addition, in this embodiment of this application, content of carbon in the steel powder is less than or equal to 0.35%; in other words, the content of content is relatively low, so that a sintering process of the green compact of the steel mechanical part is easily implemented, and difficulty in a process of preparing the steel mechanical part is reduced. In addition, the steel powder is not reinforced by using an active element such as aluminum (Al) or titanium (Ti), and has low content of carbon. For an injection molding or metal injection molding process of the steel mechanical part, a sintering process is easy to implement, and control is stably performed, and the steel mechanical part is easy to produce.

In some embodiments, in the sintering process, content of oxygen or carbon in a finally prepared steel mechanical part is adjusted by controlling temperature, time, and pressure of protective gas for sintering, so that the finally formed steel mechanical part is characterized by high strength and high toughness.

In this embodiment of this application, in a process of preparing the steel mechanical part, not only content of oxygen and content of carbon in original steel powder can be adjusted, but content of oxygen and content of carbon in a final steel mechanical part can also be adjusted by using the sintering process, and the content of oxygen or the content of carbon in the finally prepared steel mechanical part is effectively controlled.

S150: Perform thermal treatment on the sintered compact of the steel mechanical part.

In this embodiment of this application, thermal treatment is performed on the sintered compact of the steel mechanical part, and this is conducive to solid solution treatment and aging treatment of the steel mechanical part, and facilitates precipitation of a reinforcing phase, so that strength of the finally formed steel mechanical part reaches required strength.

Table 5 is a table of component content in the preparation method for a steel mechanical part provided in this application in embodiments. Table 5 reflects content of each component in the steel powder before the steel mechanical part is prepared, content of each component in the prepared steel mechanical part, and yield strength and elongation corresponding to each component.

TABLE 5

| | | | | | | | | | | | | | Performance | |
|---|---|---|---|---|---|---|---|---|---|---|---|---|---|---|
| | | | | | | | | | | | | | Yield | |
| | | Component | | | | | | | | | | | strength/ | Elongation/ |
| Embodiment | | O % | C % | Cr % | Ni % | Co % | Mo % | Si % | Mn % | Nb % | W % | Fe % | Mpa | % |
| 1 | Powder | 0.27 | 0.03 | 8.53 | 6.15 | 9.16 | 4.62 | 0.25 | 0.11 | 0 | 0 | Margin | / | / |
| | Product | 0.07 | 0.007 | 8.22 | 6.13 | 9.08 | 4.53 | 0.23 | 0.06 | 0 | 0 | Margin | 1610 | 6.4 |
| 2 | Powder | 0.39 | 0.02 | 8.15 | 6.52 | 9.48 | 4.32 | 0.28 | 0.12 | 0.38 | 0 | Margin | / | / |
| | Product | 0.27 | 0.003 | 8.13 | 6.54 | 9.52 | 4.28 | 0.23 | 0.06 | 0.35 | 0 | Margin | 1690 | 5.1 |
| 3 | Powder | 0.27 | 0.08 | 10.3 | 7.11 | 10.36 | 5.8 | 0.25 | 0.14 | 0.48 | 0 | Margin | / | / |
| | Product | 0.1 | 0.01 | 10.25 | 7.05 | 10.3 | 5.7 | 0.22 | 0.13 | 0.42 | 0 | Margin | 1560 | 7.8 |
| 4 | Powder | 0.09 | 0.02 | 9.7 | 7.49 | 10.3 | 6.03 | 0.24 | 0.26 | 0 | 0 | Margin | / | / |
| | Product | 0.005 | 0.004 | 9.58 | 7.44 | 10.25 | 5.99 | 0.22 | 0.18 | 0 | 0 | Margin | 1560 | 6.69 |
| 5 | Powder | 0.07 | 0.01 | 8.36 | 3.36 | 13.8 | 6.33 | 0.24 | 0.22 | 0 | 0 | Margin | / | / |
| | Product | 0.07 | 0.004 | 8.3 | 3.2 | 13.6 | 6.3 | 0.22 | 0.18 | 0 | 0 | Margin | 1520 | 5.1 |
| 6 | Powder | 0.09 | 0.01 | 8.32 | 6.6 | 7.6 | 6.2 | 0.39 | 0.42 | 0 | 0 | Margin | / | / |
| | Product | 0.006 | 0.002 | 8.26 | 6.5 | 7.4 | 6.1 | 0.35 | 0.38 | 0 | 0 | Margin | 1510 | 5.5 |
| 7 | Powder | 0.07 | 0.01 | 9.62 | 3.8 | 13.9 | 5.62 | 0.11 | 0.21 | 0 | 0 | Margin | / | / |
| | Product | 0.002 | 0.002 | 9.52 | 3.73 | 13.7 | 5.56 | 0.08 | 0.16 | 0 | 0 | Margin | 1570 | 5.3 |
| 8 | Powder | 0.048 | 0.01 | 8.19 | 3.9 | 13.73 | 5.73 | 0.16 | 0.09 | 0.31 | 0.18 | Margin | / | / |
| | Product | 0.003 | 0.002 | 8.15 | 3.72 | 13.78 | 5.79 | 0.18 | 0.07 | 0.34 | 0.21 | Margin | 1510 | 7.6 |
| 9 | Powder | 0.059 | 0.01 | 8.43 | 6.8 | 7.2 | 5.88 | 0.13 | 0.12 | 0.3 | 1.42 | Margin | / | / |
| | Product | 0.005 | 0.007 | 8.36 | 6.83 | 7.18 | 5.81 | 0.14 | 0.09 | 0.26 | 1.47 | Margin | 1562 | 5.6 |
| 10 | Powder | 0.28 | 0.12 | 9.13 | 3.92 | 12.39 | 5.35 | 0.23 | 0.19 | 0.15 | 1.1 | Margin | / | / |
| | Product | 0.12 | 0.03 | 9.02 | 3.88 | 12.36 | 5.33 | 0.24 | 0.17 | 0.11 | 1.16 | Margin | 1620 | 5.1 |
| 11 | Powder | 0.27 | 0.14 | 9.5 | 3.12 | 14.5 | 5.3 | 0.24 | 0.22 | 0.12 | 0.76 | Margin | / | / |
| | Product | 0.11 | 0.09 | 9.44 | 3.08 | 14.3 | 5.4 | 0.23 | 0.16 | 0.12 | 0.77 | Margin | 1510 | 6.7 |
| 12 | Powder | 0.29 | 0.11 | 7.2 | 6.11 | 8.91 | 5.42 | 0.23 | 0.12 | 0.1 | 0.15 | Margin | / | / |
| | Product | 0.12 | 0.05 | 7.11 | 6.08 | 8.88 | 5.38 | 0.21 | 0.09 | 0.11 | 0.14 | Margin | 1630 | 6.6 |
| 13 | Powder | 0.29 | 0.11 | 10.8 | 3.5 | 9.8 | 6.12 | 0.24 | 0.22 | 0.15 | 0.5 | Margin | / | / |
| | Product | 0.09 | 0.06 | 10.77 | 3.32 | 9.66 | 6.05 | 0.26 | 0.18 | 0.16 | 0.44 | Margin | 1510 | 5.2 |
| 14 | Powder | 0.08 | 0.34 | 9.5 | 3.2 | 14.5 | 5.8 | 0.25 | 0.12 | 0.15 | 1.92 | Margin | / | / |
| | Product | 0.04 | 0.32 | 9.4 | 3.15 | 14.2 | 5.6 | 0.21 | 0.07 | 0.13 | 1.86 | Margin | 1760 | 6.2 |
| 15 | Powder | 0.29 | 0.31 | 8.9 | 3.75 | 13.5 | 6.2 | 0.21 | 0.13 | 0.11 | 0.92 | Margin | / | |
| | Product | 0.03 | 0.27 | 8.8 | 3.62 | 13.48 | 6.1 | 0.19 | 0.08 | 0.09 | 0.89 | Margin | 1680 | 6.1 |
| 16 | Powder | 0.29 | 0.33 | 10.2 | 2.5 | 14.9 | 5.6 | 0.25 | 0.16 | 0 | 1.2 | Margin | / | / |
| | Product | 0.07 | 0.21 | 9.9 | 2.1 | 14.6 | 5.43 | 0.22 | 0.11 | 0 | 1.17 | Margin | 1720 | 5.8 |
| 17 | Powder | 0.28 | 0.29 | 8.9 | 2.48 | 13.8 | 6.5 | 0.26 | 0.18 | 0 | 1.3 | Margin | / | / |
| | Product | 0.05 | 0.16 | 8.76 | 2.46 | 13.2 | 5.23 | 0.22 | 0.11 | 0 | 1.26 | Margin | 1690 | 5.5 |
| 18 | Powder | 0.28 | 0.23 | 8.9 | 3.88 | 12.5 | 6.8 | 0.22 | 0.15 | 0.1 | 0.75 | Margin | / | / |
| | Product | 0.05 | 0.16 | 8.86 | 3.75 | 12.46 | 6.76 | 0.22 | 0.09 | 0.11 | 0.76 | Margin | 1650 | 6.3 |

It may be learned based on Table 5 that the steel mechanical part molded by using the preparation method for a steel mechanical part provided in this application has characteristics that yield strength is greater than or equal to 1300 Mpa and elongation is greater than or equal to 5%; in other words, the formed steel mechanical part is characterized by both high strength and high toughness, so that the steel mechanical part is not prone to deformation or fracture under high-strength force.

In addition, in this embodiment of this application, based on the steel mechanical part molded by using the preparation method for a steel mechanical part provided in this application, a three-dimensional complex and precise steel mechanical part can be effectively obtained at a time. Compared with a complex and precise steel mechanical part molded by using conventional mechanical processing such as a computerized numerical control machine (CNC), additional processing is not required, so that production efficiency of preparing the complex and precise steel mechanical part is improved, costs of preparing the steel mechanical part are reduced, and large-scale production of the steel mechanical part is facilitated.

It may be learned from Table 5 that mass percentages of components in the steel mechanical part molded by using the preparation method for a steel mechanical part provided in this application are slightly different from the mass percentages of the components in the steel powder. The preparation method for a steel mechanical part includes the sintering process, so that the content of carbon and the content of oxygen in the sintered steel mechanical part are different from the content of carbon and the content of oxygen in the steel powder, and consequently, content of a metal element (chromium, nickel, cobalt, molybdenum, or iron) in the final steel mechanical part and content of a metal element in the steel powder are slightly changed. The finally molded steel mechanical part includes: chromium: 7% to 11%, nickel: 2% to 7.5%, cobalt: 6% to 15%, molybdenum: 4% to 7%, and iron: 50% to 80%, so that the steel mechanical part includes a reinforcing phase such as a Fe—Co—Ni—Cr—Mo phase, a Fe—Co—Cr—Mo phase, and carbide (such as Mo2C or W2C).

In some embodiments, the steel mechanical part molded by using the preparation method for a steel mechanical part provided in this application has characteristics that yield strength is less than or equal to 2000 Mpa and elongation is less than or equal to 12%. Therefore, while mechanical strength of the formed steel mechanical part is ensured, difficulty in a process of preparing the steel mechanical part is reduced, so that production costs of the steel mechanical part are reduced.

In this embodiment of this application, a mass percentage of each component in the steel powder is limited, so that the steel mechanical part can be reinforced by relying on a Fe—Co—Ni—Cr—Mo phase, a Fe—Co—Cr—Mo phase, and carbide (such as Mo2C or W2C), and therefore yield strength of the steel mechanical part prepared by using a metal injection molding technology is greater than or equal to 1300 Mpa, and elongation is greater than or equal to 5%; in other words, the formed steel mechanical part is characterized by both high strength and high toughness, and the steel mechanical part is not prone to deformation or fracture under high-strength force.

For example, the steel mechanical part includes components of the following mass percentages: chromium (Cr): 7% to 11%, nickel (Ni): 2% to 7.5%, cobalt (Co): 6% to 15%, molybdenum (Mo): 4% to 7%, oxygen (O): a trace to 0.4%, carbon (C): a trace to 0.35%, and iron: 50% to 80%. The mass percentage of each component in the steel mechanical part is different, and components of the reinforcing phase are also different; in other words, a formed Fe—Co—Ni—Cr—Mo phase, Fe—Co—Cr—Mo phase, or carbide is different. The reinforcing phase may be but is not limited to (Fe, Co, Ni) 17Cr8Mo18, (Fe, Co) 15Cr8Mo4, (Fe, Co) 16Cr8Mo18, or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Embodiments of this application and features in the embodiments may be combined with each other in a case of no conflicts. Therefore, the protection scope of this application shall be subject to the protection scope of the claims.

1. Steel, comprising components of the following mass percentages:
chromium: 7% to 11%, nickel: 2% to 7.5%, cobalt: 6% to 15%, molybdenum: 4% to 7%, oxygen: a trace to 0.4%, carbon: a trace to 0.35%, and iron: 50% to 80%.

2. The steel according to claim 1, wherein the steel further comprises niobium and a mass percentage of the niobium is a trace to 1%.

3. The steel according to claim 1, wherein the steel further comprises tantalum and a mass percentage of the tantalum is a trace to 2%.

4. The steel according to claim 1, wherein the steel further comprises tantalum and niobium, wherein a ratio of a mass percentage of the tantalum to a mass percentage of the niobium is (1 to 2):1, and wherein the mass percentage of the tantalum plus the mass percentage of the niobium is a trace to 1.5%.

5. The steel according to claim 1, wherein the steel further comprises tungsten and a mass percentage of the tungsten is a trace to 2%.

6. The steel according to claim 1, wherein the steel further comprises silicon and manganese, wherein a mass percentage of the silicon is a trace to 0.5%₇ and a mass percentage of the manganese is a trace to 0.5%.

7. The steel according to claim 1, wherein a mass percentage of the chromium is 7% to 9% and a mass percentage of the cobalt is 7% to 14%.

8. The steel according to claim 1, wherein the steel further comprises boron and a percentage of the boron is a trace to 0.01%.

9. The steel according to claim 1, wherein the steel further comprises a rare earth element and a mass percentage of the rare earth element is a trace to 0.5%.

10. The steel according to claim 1, wherein the steel further comprises another element, the another element comprises one or more of nitrogen, rhenium, copper, aluminum, titanium, sulfur, phosphorus, hydrogen, zirconium, magnesium, calcium, yttrium, vanadium, scandium, or zinc, and a mass percentage of the another element is ≤1%.

11. An electronic device, comprising a steel mechanical part, wherein a material used by the steel mechanical part comprises steel comprising components of the following mass percentages:
chromium: 7% to 11%, nickel: 2% to 7.5%, cobalt: 6% to 15%, molybdenum: 4% to 7%, oxygen: a trace to 0.4%, carbon: a trace to 0.35%, and iron: 50% to 80%.

12. The steel according to claim 11, wherein the steel further comprises niobium and a mass percentage of the niobium is a trace to 1%.

13. The steel according to claim 11, wherein the steel further comprises tantalum and a mass percentage of the tantalum is a trace to 2%.

14. The steel according to claim 11, wherein the steel further comprises tantalum and niobium, wherein a ratio of a mass percentage of the tantalum to a mass percentage of the niobium is (1 to 2):1, and wherein the mass percentage of the tantalum plus the mass percentage of the niobium is a trace to 1.5%.

15. The steel according to claim 11, wherein the steel further comprises tungsten and a mass percentage of the tungsten is a trace to 2%.

16. The steel according to claim 11, wherein the steel further comprises silicon and manganese, wherein a mass percentage of the silicon is a trace to 0.5%, and a mass percentage of the manganese is a trace to 0.5%.

17. The steel according to claim 11, wherein a mass percentage of the chromium is 7% to 9%₇ and a mass percentage of the cobalt is 7% to 14%.

18. The steel according to claim 1, wherein the steel further comprises boron and a percentage of the boron is a trace to 0.01%.

19. The steel according to claim 11, wherein the steel further comprises a rare earth element and a mass percentage of the rare earth element is a trace to 0.5%.

20. A steel mechanical part, wherein a material used by the steel mechanical part comprising steel comprising components of the following mass percentages:
chromium: 7% to 11%, nickel: 2% to 7.5%, cobalt: 6% to 15%, molybdenum: 4% to 7%, oxygen: a trace to 0.4%, carbon: a trace to 0.35%, and iron: 50% to 80%.
